(19) United States
(12) Patent Application Publication
(10) Pub. No.: US 2019/0082414 A1
(43) Pub. Date: Mar. 14, 2019

(54) METHOD AND DEVICE FOR REPORTING TERMINAL LOCATIONS IN A VEHICLE COMMUNICATION

(71) Applicant: YULONG COMPUTER TELECOMMUNICATION SCIENTIFIC (SHENZHEN) CO., LTD., Shenzhen (CN)

(72) Inventor: YI-XUE LEI, Shenzhen (CN)

(21) Appl. No.: 16/082,281

(22) PCT Filed: Oct. 31, 2016
(86) PCT No.: PCT/CN2016/104058

§ 371 Date: Sep. 5, 2018

(30) Foreign Application Priority Data
Mar. 7, 2016 (CN) 201610128580.1

(51) Int. Cl. H04W 64/00; H04W 4/02; H04W 4/40; G01S 5/00

(52) U.S. Cl. CPC H04W 64/003; H04W 4/023; G01S 5/009; G01S 5/0027; G01S 5/0072; H04W 4/40

(57) ABSTRACT

A method for reporting terminal location in a vehicle communication includes: detecting a location relationship with other terminals by a terminal, to determine a target terminal related to a location of the terminal. Location correlation information between the terminal and the target terminal to a base station or network side equipment is reported, to enable the base station or the network side equipment to select a terminal that needs to report a location from the terminal and the target terminal according to the location correlation information. By utilizing embodiments of the present disclosure, when a terminal reports a location, it is unnecessary for all terminals to report locations, unnecessary location reporting messages are reduced, loads on a base station or a network side caused by the terminals reports the locations are decreased, and also uplink resources of the base station or the network side are saved.

### CROSS-REFERENCE TO RELATED APPLICATIONS

This application claims priority of Chinese Patent Application No. 201610128580.1, entitled “method and device for reporting terminal locations in a vehicle communication,” filed on Mar. 7, 2016 in the SIPO (State Intellectual Property Office of the People's Republic of China), the entire contents of which are incorporated by reference herein.

### FIELD

The embodiments of the present disclosure relates to a technical field of communication, specifically a method for reporting terminal locations in a vehicle communication and a device for reporting terminal locations in a vehicle communication.

### BACKGROUND

Vehicle-to-everything (Vehicle to X, a communication from a vehicle to a specific target) is a project approved by 3rd Generation Partnership Project (3GPP) RAN#68, which mainly researches solutions for vehicle data transmission based on the 3GPP communication protocol. The V2X includes a vehicle-to-vehicle (V2V), a vehicle-to-individual person (V2P), a vehicle-to-infrastructure (V2I), etc. In principle, a V2V communication can be performed through a Uu interface (an interface between user equipment and a base station) and a PC5 interface (an interface between the user equipment and the user equipment). An existing downlink transmission mechanism includes a Uu interface unicast, a Uu interface Enhanced Multimedia Broadcast Multicast Service (eMBMS), which supports a multi-cell broadcast service, and a single-cell broadcast mechanism, which is single-cell point to multi-point (PTM).

The V2V communication mechanism based on the PC5/a device-to-device (D2D) is regarded as a mainstream technology of LTE-based V2V, as it does not occupy a wireless carrying resource of a macro network during a data transmission at a user-side, and this mechanism can naturally realize space division multiplexing. However, since the base station needs to acquire a terminal location to allocate wireless resources in a V2X scheduling, for location-related vehicle user equipment (UE), redundant location reporting messages are generated if each UE reports a location message, which causes a heavy load on the base station or a network side. Moreover, if each UE reports a location message, it will occupy more uplink resources.

Therefore, it is a technical problem to be solved on how to reduce unnecessary location reporting messages, to decrease the loads on the base station or the network side, and to save uplink resources.

### SUMMARY

The at least one of the above technical problems to be solved by embodiments of the present disclosure is to provide a new terminal location reporting solution in a vehicle communication, thus, when a terminal reports a location, it is unnecessary for all terminals to report locations, unnecessary location reporting messages are reduced, loads on a base station or on a network side caused by the terminals report the locations are decreased, and also uplink resources of the base station or the network side are saved.

In order to solve the above technical problems, according to a first embodiment of the present disclosure, a method for reporting terminal locations in a vehicle communication is provided and includes: a terminal detects a location relationship with other terminals, to determine a target terminal related to a location of the terminal, reporting location correlation information between the terminal and the target terminal to a base station or network side equipment, to enable the base station or the network side equipment to select a terminal that needs to report a location from the terminal and the target terminal according to the location correlation information.

In the above embodiment, the terminal determines the target terminal related to its location and reports the location correlation information with the target terminal to the base station or the network side equipment. The base station or the network side equipment selects a terminal that needs to report a location according to the location correlation information. For a plurality of terminals relevant to the location, the base station or the network side equipment can only select some of the plurality terminals for reporting locations, and then the base station or the network side equipment can determine a current location of each terminal according to location information reported by the some of the plurality of terminals and location correlation information between the plurality terminals. It is not necessary for all the terminals to report their own locations, unnecessary location reporting messages is thus reduced, loads on a base station or a network side are decreased when the single terminal reports the locations, and uplink resources of the base station or the network side also can be saved.

In the above embodiment, optionally, the step of detecting a location relationship with other terminals to determine a target terminal related to a location of the terminal specific includes:

Acquiring information of the target terminal related to the location of the terminal from an application layer of the terminal; and/or

Determining the target terminal related to the location of the terminal through a Device-to-Device (D2D) discovery mechanism.

In the above embodiment, for example, for vehicles traveling in formation, their location correlations are certainly existed, and such formation information can be obtained from the application layer. Therefore, the terminal can acquire the information of the target terminal related to the location of the terminal from the application layer. In addition, the terminal can also determine whether there is a location correlation with surrounding terminals through the D2D discovery mechanism, so as to determine the target terminal.

In the above embodiment, optionally, the step of determining the target terminal related to the location of the terminal through a D2D discovery mechanism includes: when a location variable between the terminal and any terminal, within a unit time and determinable as being within a predetermined range through the D2D discovery mechanism, determining that a location correlation between the terminal and the any terminal does exist.

In the above embodiment, generally, for two terminals having a location correlation, a distance between the two terminals is stable for a certain period of time. Thus, it is possible to determine whether there is a location correlation between terminals by determining whether the location variable between the terminals within a unit time is within a predetermined range.

In the above embodiment, optionally, the method also includes: determining whether a location reporting configuration instruction sent by the base station or the network side equipment is received; after determining that the location reporting configuration instruction is received, reporting current location information of the terminal to the base station or the network side equipment according to the location reporting configuration instruction, to determine locations of the terminal and the target terminal by the base station or the network side equipment according to the current location information and the location correlation information.

In the above embodiment, when a terminal receives the location reporting configuration instruction send by the base station or the network side equipment, it is indicated that the base station or the network side equipment selects a terminal as the terminal that needs to report a location. Therefore, the selected terminal can report its current location information to the base station or the network side equipment according to the location reporting configuration instruction. Then the base station or the network side equipment can determine locations of the selected terminal and other terminal according to the current location information of the selected terminal and the location correlation information between the selected terminal and the other terminal.

According to a second embodiment of the present disclosure, another method for reporting terminal locations in a vehicle communication is provided and includes: acquiring location correlation information between a plurality of terminals; selecting a designated terminal that needs to report a location from the plurality of terminals, according to the location correlation information; sending a location reporting configuration instruction to the designated terminal, to make the designated terminal report its location information according to the location reporting configuration instruction; determining locations of the plurality of terminals, according to the location information of the designated terminal and the location correlation information.

In the above embodiment, the base station or the network side equipment selects the designated terminal that needs to report the location from plurality of terminals related to the locations, The designated terminal is thus enabled to report the location, and to determine the locations of the plurality of terminals according to the location information of the designated terminal and the location correlation information between the plurality of terminals. Thus, it is unnecessary for all terminals to report locations, when the locations of the plurality of terminals are needed to acquire. Thereby, unnecessary location reporting messages is reduced, loads on a base station or a network side are decreased when the designated terminal reports the location, and uplink resources of the base station or the network side are also saved.

In the above embodiment, optionally, the step of acquiring location correlation information between a plurality of terminals specifically includes: receiving the location correlation information send by any one of the plurality of terminals; and/or

Receiving location information reported by each of the plurality of terminals, and determining location correlation information between the plurality of terminals according to the location information reported by each of the plurality of terminals.

Specifically, after determining the location correlation information between the plurality of terminals, the terminal can directly send the location correlation information to the base station or the network side equipment. Moreover, the base station or the network side equipment can determine the location correlation information of the plurality of terminals according to the location information reported by each of the plurality of terminals.

According to a third embodiment of the present disclosure, a device for reporting terminal locations in a vehicle communication is provided and executable on the terminal, includes: a detection module, is configured to detect a location relationship between the terminal and other terminals, to determine a target terminal related to a location of the terminal; a report module, is configured to report location correlation information between the terminal and the target terminal to a base station or network side equipment, to enable the base station or the network side equipment to select a terminal that needs to report a location from the terminal and the target terminal according to the location correlation information.

In the above embodiment, the terminal determines the target terminal related to its location and reports the location correlation information with the target terminal to the base station or the network side equipment. The base station or the network side equipment selects a terminal that needs to report a location according to the location correlation information. For a plurality of terminals relevant to the location, the base station or the network side equipment can only select some of the plurality terminals for reporting locations, and then the base station or the network side equipment can determine a current location of each terminal according to location information reported by the some of the plurality of terminals and location correlation information between the plurality terminals. It is not necessary for all the terminals to report their own locations, unnecessary location reporting messages is thus reduced, loads on a base station or a network side are decreased when the single terminal reports the locations, and uplink resources of the base station or the network side also can be saved.

In the above embodiment, optionally, the detection module includes:

An acquisition module, is configured to acquire information of the target terminal related to the location of the terminal from an application layer of the terminal; and/or

An determination module, is configured to determine the target terminal related to the location of the terminal through a Device-to-Device (D2D) discovery mechanism.

In the above embodiment, for example, for vehicles traveling in formation, their location correlations are certainly existed, and such formation information can be obtained from the application layer. Therefore, the terminal can acquire the information of the target terminal related to the location of the terminal from the application layer. In addition, the terminal can also determine whether there is a location correlation with surrounding terminals through the D2D discovery mechanism, so as to determine the target terminal.

In the above embodiment, optionally, the determination module is specifically configured to determine that a location correlation between the terminal and the any terminal does exist, when a location variable between the terminal and any terminal, within a unit time and determinable as being within a predetermined range through the D2D discovery mechanism.

In the above embodiment, generally, for two terminals having a location correlation, a distance between the two terminals is stable for a certain period of time. Thus, it is possible to determine whether there is a location correlation between terminals by determining whether the location variable between the terminals within a unit time is within a predetermined range.

In the above embodiment, optionally, the a device for reporting terminal locations also includes: a judgment module configured to judge whether a location reporting configuration instruction sent by the base station or the network side equipment is received; after the judgment module determining that the location reporting configuration instruction is received, the report module also configured to report current location information of the terminal to the base station or the network side equipment according to the location reporting configuration instruction, to determine locations of the terminal and the target terminal by the base station or the network side equipment according to the current location information and the location correlation information.

In the above embodiment, when a terminal receives the location reporting configuration instruction send by the base station or the network side equipment, it is indicated that the base station or the network side equipment selects a terminal as the terminal that needs to report a location. Therefore, the selected terminal can report its current location information to the base station or the network side equipment according to the location reporting configuration instruction. Then the base station or the network side equipment can determine locations of the selected terminal and other terminal according to the current location information of the selected terminal and the location correlation information between the selected terminal and the other terminal.

According to a fourth embodiment of the present disclosure, another a device for reporting terminal locations in vehicle communication is provided, executable on a base station or network side equipment, includes: an acquisition module configured to acquire location correlation information between a plurality of terminals; a selection module configured to select a designated terminal that needs to report a location from the plurality of terminals, according to the location correlation information; a sending module configured to send a location reporting configuration instruction to the designated terminal, to make the designated terminal report its location information according to the location reporting configuration instruction; and a processing module configured to determine locations of the plurality of terminals, according to the location information of the designated terminal and the location correlation information.

In the above embodiment, the base station or the network side equipment selects the designated terminal that needs to report the location from plurality of terminals related to the locations, The designated terminal is thus enabled to report the location, and to determine the locations of the plurality of terminals according to the location information of the designated terminal and the location correlation information between the plurality of terminals. Thus, it is unnecessary for all terminals to report locations, when the locations of the plurality of terminals are needed to acquire. Thereby, unnecessary location reporting messages is reduced, loads on a base station or a network side are decreased when the designated terminal reports the location, and uplink resources of the base station or the network side are also saved.

In the above embodiment, optionally, the acquisition module includes:

A first receiving module configured to receive the location correlation information send by any one of the plurality of terminals; and/or

A second receiving module configured to receive location information reported by each of the plurality of terminals, and a determination module, is configured to determine location correlation information between the plurality of terminals according to the location information reported by each of the plurality of terminals.

Specifically, after determining the location correlation information of the plurality of terminals, the terminal can directly send the location correlation information to the base station or the network side equipment. Moreover, the base station or the network side equipment can determine the location correlation information of the plurality of terminals according to the location information reported by each of the plurality of terminals.

Through the above technical solutions, when a terminal reports a location, it is unnecessary for all terminals to report locations, unnecessary location reporting messages are reduced, loads on a base station or a network side caused by the terminals reports the locations are decreased, and also uplink resources of the base station or the network side are saved.

### BRIEF DESCRIPTION OF THE DRAWINGS

FIG. 1 is a flow diagram of a method for reporting terminal locations in a vehicle communication provided in an embodiment of the present disclosure;

FIG. 2 is a schematic structural diagram of a device for reporting terminal locations in a vehicle communication provided in an embodiment of the present disclosure;

FIG. 3 is a flow diagram of a method for reporting terminal locations in a vehicle communication provided in another embodiment of the present disclosure;

FIG. 4 is a schematic structural diagram of a device for reporting terminal locations in a vehicle communication provided in another embodiment of the present disclosure;

FIG. 5 is a schematic structural diagram showing detecting and reporting of a location correlation of UE by a terminal provided in an embodiment of the present disclosure;

FIG. 6 is a schematic structural diagram showing detecting of a location correlation of UE by a base station and a network side provided in an embodiment of the present disclosure;

FIG. 7 is a structure diagram of a terminal provided in an embodiment of the present disclosure;

FIG. 8 is a structure diagram of a base station provided in an embodiment of the present disclosure.

### DETAILED DESCRIPTION

For clarity of illustration of objectives, features and advantages of the present disclosure, the drawings combined with detailed description illustrate the embodiments of the present disclosure hereinafter. It is noted that embodiment of the present disclosure and features of the embodiments can be combined, when there is no conflict.

Various details are described in the following descriptions for better understanding of the present disclosure, however, the present disclosure may also be implemented in other ways other than those described herein. The scope of the present disclosure is not to be limited by the specific embodiments disclosed below.

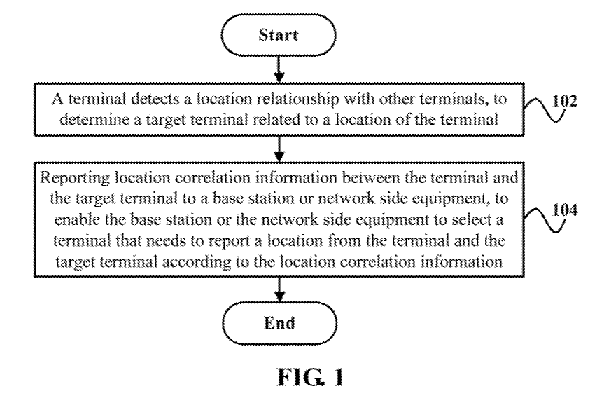

FIG. 1 shows a flow diagram of a method for reporting terminal locations in a vehicle communication provided in an embodiment of the present disclosure, the method includes:

Step 102, a terminal detects a location relationship with other terminals, to determine a target terminal related to a location of the terminal.

Step 104, reporting location correlation information between the terminal and the target terminal to a base station or network side equipment, to enable the base station or the network side equipment to select a terminal that needs to report a location from the terminal and the target terminal according to the location correlation information.

In the above embodiment, the terminal determines the target terminal related to its location and reports the location correlation information with the target terminal to the base station or the network side equipment. The base station or the network side equipment selects a terminal that needs to report a location according to the location correlation information. For a plurality of terminals relevant to the location, the base station or the network side equipment can only select some of the plurality terminals for reporting locations, and then the base station or the network side equipment can determine a current location of each terminal according to location information reported by the some of the plurality of terminals and location correlation information between the plurality terminals. It is not necessary for all the terminals to report their own locations, unnecessary location reporting messages is thus reduced, loads on a base station or a network side are decreased when the single terminal reports the locations, and uplink resources of the base station or the network side also can be saved.

In the above embodiment, optionally, the step of detecting a location relationship with other terminals to determine a target terminal related to a location of the terminal includes:

Acquiring information of the target terminal related to the location of the terminal from an application layer of the terminal; and/or

Determining the target terminal related to the location of the terminal through a Device-to-Device (D2D) discovery mechanism.

In the above embodiment, for example, for vehicles traveling in formation, their location correlations are certainly existed, and such formation information can be obtained from the application layer. Therefore, the terminal can acquire the information of the target terminal related to the location of the terminal from the application layer. In addition, the terminal can also determine whether there is a location correlation with surrounding terminals through the D2D discovery mechanism, so as to determine the target terminal.

In the above embodiment, optionally, the step of determining the target terminal related to the location of the terminal through a D2D discovery mechanism includes: when a location variable between the terminal and any terminal, within a unit time and determinable as being within a predetermined range through the D2D discovery mechanism, determining that a location correlation between the terminal and the any terminal does exist. In the above embodiment, generally, for two terminals having a location correlation, a distance between the two terminals is stable for a certain period of time. Thus, it is possible to determine whether there is a location correlation between terminals by determining whether the location variable between the terminals within a unit time is within a predetermined range.

In the above embodiment, optionally, the method also includes: determining whether a location reporting configuration instruction sent by the base station or the network side equipment is received; after determining that the location reporting configuration instruction is received, reporting current location information of the terminal to the base station or the network side equipment according to the location reporting configuration instruction, to determine locations of the terminal and the target terminal by the base station or the network side equipment according to the current location information and the location correlation information.

In the above embodiment, when a terminal receives the location reporting configuration instruction send by the base station or the network side equipment, it is indicated that the base station or the network side equipment selects a terminal as the terminal that needs to report a location. Therefore, the selected terminal can report its current location information to the base station or the network side equipment according to the location reporting configuration instruction. Then the base station or the network side equipment can determine locations of the selected terminal and other terminal according to the current location information of the selected terminal and the location correlation information between the selected terminal and the other terminal.

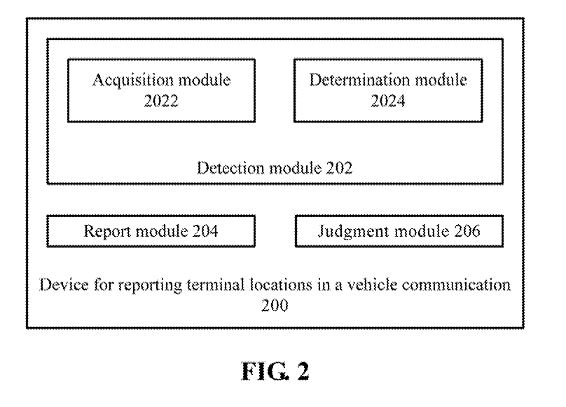

FIG. 2 shows a schematic structural diagram of a device for reporting terminal locations in a vehicle communication provided in an embodiment of the present disclosure.

As shown in FIG. 2, a device for reporting terminal locations 200 in vehicle communication according to an embodiment of the present disclosure, executable on the terminal, a detection module 202 and a report module 204.

The detection module 202, is configured to detect a location relationship between the terminal and other terminals, to determine a target terminal related to a location of the terminal; the report module 204, is configured to report location correlation information between the terminal and the target terminal to a base station or network side equipment, to enable the base station or the network side equipment to select a terminal that needs to report a location from the terminal and the target terminal according to the location correlation information.

In the above embodiment, the terminal determines the target terminal related to its location and reports the location correlation information with the target terminal to the base station or the network side equipment. The base station or the network side equipment selects a terminal that needs to report a location according to the location correlation information. For a plurality of terminals relevant to the location, the base station or the network side equipment can only select some of the plurality terminals for reporting locations, and then the base station or the network side equipment can determine a current location of each terminal according to location information reported by the some of the plurality of terminals and location correlation information between the plurality terminals. It is not necessary for all the terminals to report their own locations, unnecessary location reporting messages is thus reduced, loads on a base station or a network side are decreased when the single terminal reports the locations, and uplink resources of the base station or the network side also can be saved.

In the above embodiment, optionally, the detection module 202 includes:

An acquisition module 2022, is configured to acquire information of the target terminal related to the location of the terminal from an application layer of the terminal; and/or

An determination module 2024, is configured to determine the target terminal related to the location of the terminal through a Device-to-Device (D2D) discovery mechanism.

In the above embodiment, for example, for vehicles traveling in formation, their location correlations are certainly existed, and such formation information can be obtained from the application layer. Therefore, the terminal can acquire the information of the target terminal related to the location of the terminal from the application layer. In addition, the terminal can also determine whether there is a location correlation with surrounding terminals through the D2D discovery mechanism, so as to determine the target terminal.

In the above embodiment, optionally, the determination module 2024, is specifically configured to determine that a location correlation between the terminal and the any terminal does exist, when a location variable between the terminal and any terminal, within a unit time and determinable as being within a predetermined range through the D2D discovery mechanism.

In the above embodiment, generally, for two terminals having a location correlation, a distance between the two terminals is stable for a certain period of time. Thus, it is possible to determine whether there is a location correlation between terminals by determining whether the location variable between the terminals within a unit time is within a predetermined range.

In the above embodiment, optionally, the device for reporting terminal locations 200 also includes: a judgment module 206, is configured to judge whether a location reporting configuration instruction sent by the base station or the network side equipment is received; after the judgment module 206 determining that the location reporting configuration instruction is received, the report module 204 is also configured to report current location information of the terminal to the base station or the network side equipment according to the location reporting configuration instruction, to determine locations of the terminal and the target terminal by the base station or the network side equipment according to the current location information and the location correlation information.

In the above embodiment, when a terminal receives the location reporting configuration instruction send by the base station or the network side equipment, it is indicated that the base station or the network side equipment selects a terminal as the terminal that needs to report a location. Therefore, the selected terminal can report its current location information to the base station or the network side equipment according to the location reporting configuration instruction. Then the base station or the network side equipment can determine locations of the selected terminal and other terminal according to the current location information of the selected terminal and the location correlation information between the selected terminal and the other terminal.

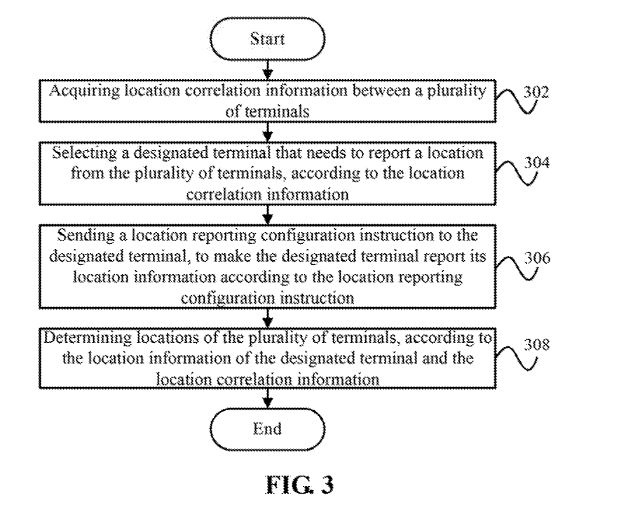

FIG. 3 shows a flow diagram of a method for reporting terminal locations in a vehicle communication provided in another embodiment of the present disclosure.

As shown in FIG. 3, a method for reporting terminal locations in a vehicle communication according to another embodiment of the present disclosure, includes:

Step 302, acquiring location correlation information between a plurality of terminals;

Step 304, selecting a designated terminal that needs to report a location from the plurality of terminals, according to the location correlation information.

Step 306, sending a location reporting configuration instruction to the designated terminal, to make the designated terminal report its location information according to the location reporting configuration instruction.

Step 308, determining locations of the plurality of terminals, according to the location information of the designated terminal and the location correlation information.

In the above embodiment, the base station or the network side equipment selects the designated terminal that needs to report the location from plurality of terminals related to the locations, The designated terminal is thus enabled to report the location, and to determine the locations of the plurality of terminals according to the location information of the designated terminal and the location correlation information between the plurality of terminals. Thus, it is unnecessary for all terminals to report locations, when the locations of the plurality of terminals are needed to acquire. Thereby, unnecessary location reporting messages is reduced, loads on a base station or a network side are decreased when the designated terminal reports the location, and uplink resources of the base station or the network side are also saved.

In the above embodiment, optionally, the step of acquiring location correlation information between a plurality of terminals specifically includes: receiving the location correlation information send by any one of the plurality of terminals; and/or

Receiving location information reported by each of the plurality of terminals, and determining location correlation information between the plurality of terminals according to the location information reported by each of the plurality of terminals.

Specifically, after determining the location correlation information between the plurality of terminals, the terminal can directly send the location correlation information to the base station or the network side equipment. Moreover, the base station or the network side equipment can determine the location correlation information of the plurality of terminals according to the location information reported by each of the plurality of terminals.

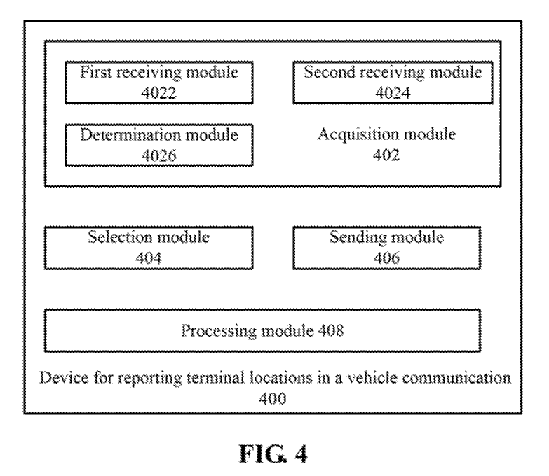

FIG. 4 shows a schematic structural diagram of a device for reporting terminal locations in a vehicle communication provided in another embodiment of the present disclosure.

As shown in FIG. 4, a device for reporting terminal locations 400 in vehicle communication according to another embodiment of the present disclosure, executable on a base station or network side equipment, includes:

An acquisition module 402, is configured to acquire location correlation information between a plurality of terminals; a selection module 404, is configured to select a designated terminal that needs to report a location from the plurality of terminals, according to the location correlation information; a sending module 406, is configured to send a location reporting configuration instruction to the designated terminal, to make the designated terminal report its location information according to the location reporting configuration instruction; and a processing module 408, is configured to determine locations of the plurality of terminals, according to the location information of the designated terminal and the location correlation information.

In the above embodiment, the base station or the network side equipment selects the designated terminal that needs to report the location from plurality of terminals related to the locations, The designated terminal is thus enabled to report the location, and to determine the locations of the plurality of terminals according to the location information of the designated terminal and the location correlation information between the plurality of terminals. Thus, it is unnecessary for all terminals to report locations, when the locations of the plurality of terminals are needed to acquire. Thereby, unnecessary location reporting messages is reduced, loads on a base station or a network side are decreased when the designated terminal reports the location, and uplink resources of the base station or the network side are also saved.

In the above embodiment, optionally, the acquisition module 402 includes:

A first receiving module 4022, is configured to receive the location correlation information send by any one of the plurality of terminals; and/or

A second receiving module 4024, is configured to receive location information reported by each of the plurality of terminals, and a determination module 4026, is configured to determine location correlation information between the plurality of terminals according to the location information reported by each of the plurality of terminals.

Specifically, after determining the location correlation information of the plurality of terminals, the terminal can directly send the location correlation information to the base station or the network side equipment. Moreover, the base station or the network side equipment can determine the location correlation information of the plurality of terminals according to the location information reported by each of the plurality of terminals.

In conclusion, the present disclosure mainly provides a solution to reduce UE location reporting by using cooperation between UE. A basic point of the solution is for a location-related (such as close to or has a certain association relationship) terminal can select one UE to repot location to reduce unnecessary repeated reporting, thus occupation of uplink resources can be decreased. The base station or the network side equipment can infer the current locations of other terminals for scheduling, when receiving the location information reported by the one UE and the locational relevance between the terminals.

Before the base station or the network side equipment selects the UE for reporting location, the location correlation of the UE needs to be known first. The solution for detecting the location correlation of the UE provided in the present disclosure can be realized by either a terminal side or the base station or the network side. Details are as follows:

1. The Terminal Side Implements a Detection of the Location Correlation of the UE:

The terminals determine the location correlation and then send the location correlation to the base station or the network side equipment. Among them, the solution that the UE detects the location correlation with other UE includes, but is not limit to:

(1) The UE can determine whether there is a location correlation with the other UEs through the application layer mechanism. For example, location correlation of vehicles traveling in formation is certainly existing, and such formation information can be obtained from the application layer. This correlation cannot be found when the formation does not exist.

(2) The UE can determine whether there is a location correlation with surrounding UEs through the D2D discovery mechanism. IF continuous discovery is made for a certain period of time, it can be judged whether a distance between two UEs remains stable. Specifically, if relative locations of the two UEs are substantially stable (e.g., a location variable within a unit time is within a predetermined range), the location can be determined to be related, this determination solution can be determined comprehensively by combining with a lane and driving direction information.

After the UE determines that the location correlation is obtained, one of the vehicle UEs reports to the base station or the network side equipment. The base station or the network side equipment can use this as a basis to select which UE needs to report a location and which UE does not need to do so. Of course, in order to avoid a plurality of UEs in a specific area reporting a location correlation at the same time, only one UE can trigger reporting the location correlation after the UE determines the location correlation.

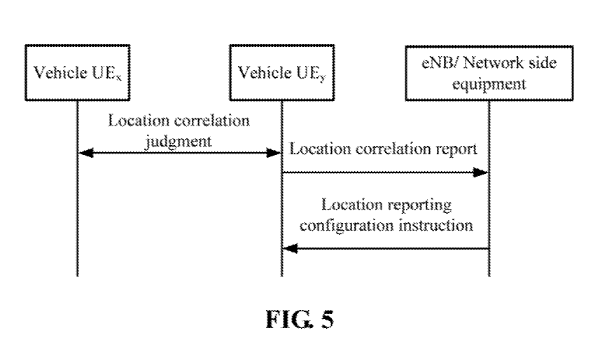

A specific process is shown in FIG. 5, a location correlation between Vehicle UEx and Vehicle UEy is determined. The Vehicle UEy reports the location correlation to an evolved nodeB (eNB) or a network side equipment. Then the eNB or the network side equipment selects a UE that needs to report a location correlation (it is assumed that the eNB or the network side equipment selects the Vehicle UEy as the UE for reporting location) according to the location correlation and sends a location reporting configuration instruction to the selected UE.

2. The Base Station or the Network Side Equipment Implements the Detection of the Location Correlation Between UEs:

In this solution, each UE can report its own location information to the eNB or the network side equipment. Then based on this, the eNB or the network side equipment can analyze the location correlation between the UEs, and select which UE needs to report location and which UE does not need to do so, according to the location correlation.

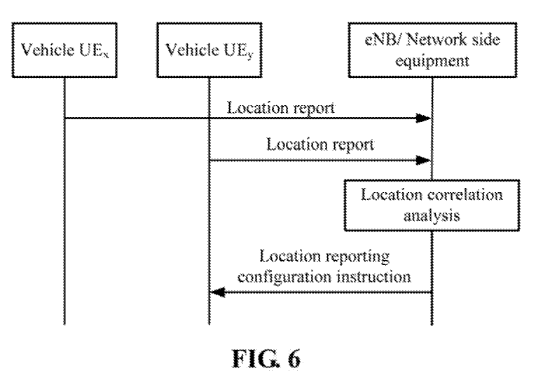

Specifically, as shown in FIG. 6, the Vehicle UEx and the Vehicle UEy continuously report location, the eNB or the network side equipment can analyze the location correlation between the UEs, the eNB or the network side equipment can then select a UE that needs to report a location correlation (it is assumed that the eNB or the network side equipment selects the Vehicle UEy as the UE for location reporting), and send a location reporting configuration instruction to the selected UE.

The following illustrates a specific application scenario of the present disclosure: a plurality of vehicle Ues are located under a coverage of a same macro cell. If directions and lanes of the plurality of vehicle UEs are the same, in general, in the case of no overtaking and lane change, the driving speed is almost the same and the distance is basically kept. In this case, if the formation driving has already started, only one of the vehicles (such as a vehicle at the head of a team) is required to report the location. Optionally, an estimated location of other vehicles can also be carried in the location reporting, the eNB or the network side equipment uses the estimated location as a reference to determine the location of the other vehicles.

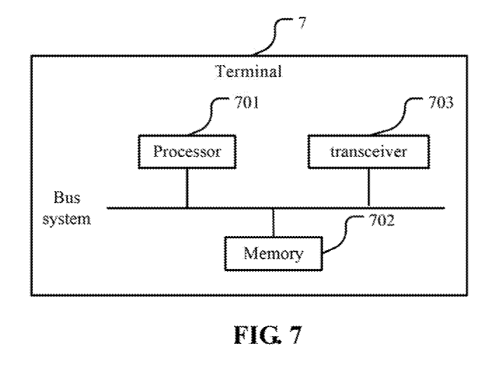

FIG. 7 shows a structure diagram of a terminal of an embodiment in the present disclosure.

Referring to FIG. 7, FIG. 7 is a structure diagram of a terminal provided in an embodiment in the present disclosure. In this embodiment of the present disclosure, a terminal 7 includes: a processor 701, a memory 702 and a transceiver 703. The transceiver 703 is used to send and receive data from external devices. A number of the processor 701 of the terminal 7 maybe one or more. In some embodiments of the present disclosure, the processor 701, the memory 702 and the transceiver 703 can be connected through a bus system or other ways. The terminal 7 can be used to execute the method shown in FIG. 1.

In which, the memory 702 stores program codes, and the processor 701 can invoke the program codes stored in the memory 702 to perform corresponding functions through the bus system. For example, each of the various modules in FIG. 2 (e.g., the detection module 202, the report module 204, the judgment module 206, etc.) are program codes stored in the memory 702 and are executed by the processor 701, to perform the functions of the various modules for reporting terminal locations in a vehicle communication.

Specifically, the processor 701 detects a location relationship with other terminals, to determine a target terminal related to a location of the terminal; reports location correlation information between the terminal and the target terminal to a base station or network side equipment, to enable the base station or the network side equipment to select a terminal that needs to report a location from the terminal and the target terminal according to the location correlation information.

In a further embodiment, the processor 701 acquires information of the target terminal related to the location of the terminal from an application layer of the terminal; and/or

Determines the target terminal related to the location of the terminal through a D2D discovery mechanism.

In a further embodiment, the processor 701 determines that a location correlation between the terminal and the any terminal does exist, when a location variable between the terminal and any terminal, within a unit time and determinable as being within a predetermined range through the D2D discovery mechanism.

In a further embodiment, the processor 701 determines whether a location reporting configuration instruction sent by the base station or the network side equipment is received; after determining that the location reporting configuration instruction is received, reports current location information of the terminal to the base station or the network side equipment according to the location reporting configuration instruction, to determine locations of the terminal and the target terminal by the base station or the network side equipment according to the current location information and the location correlation information.

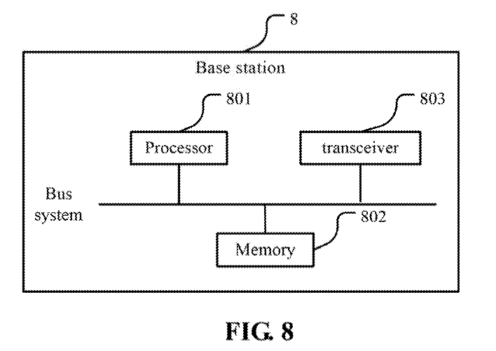

FIG. 8 shows a structure diagram of a base station of an embodiment in the present disclosure.

Referring to FIG. 8, FIG. 8 is a structure diagram of a base station provided in an embodiment in the present disclosure. In this embodiment of the present disclosure, a base station 8 includes: a processor 801, a memory 802 and a transceiver 803. The transceiver 803 is used to send and receive data from external devices. A number of the processor 801 of the terminal 8 maybe one or more. In some embodiments of the present disclosure, the processor 7801, the memory 802 and the transceiver 803 can be connected through a bus system or other ways. The base station 8 can be used to execute the method shown in FIG. 3.

In which, the memory 802 stores program codes, and the processor 801 can invoke the program codes stored in the memory 802 to perform corresponding functions through the bus system. For example, each of the various modules in FIG. 4 (e.g., the acquisition module 402, the selection module 404, the sending module 406, the processing module 408, etc.) are program codes stored in the memory 802 and are executed by the processor 801, to perform the functions of the various modules for reporting terminal locations in a vehicle communication.

Specifically, the processor 801 acquires location correlation information between a plurality of terminals; selects a designated terminal that needs to report a location from the plurality of terminals, according to the location correlation information; sends a location reporting configuration instruction to the designated terminal, to make the designated terminal report its location information according to the location reporting configuration instruction; determines locations of the plurality of terminals, according to the location information of the designated terminal and the location correlation information.

In a further embodiment, the processor 801 receives the location correlation information send by any one of the plurality of terminals; and/or

In a further embodiment, the processor 801 receives location information reported by each of the plurality of terminals, and determines location correlation information of the plurality between terminals according to the location information reported by each of the plurality of terminals.

It should be noted that, in order to support the solution provided in the present disclosure, it is need to define a new radio resource control (RRC) signaling messages or other interface messages of Vehicle UE and a network-side entity, such as a PC3 interface defined by a reuse D2D protocol.

The present disclosure has been explicated above by referring to the drawings. The present disclosure provides a new location reporting method for terminal in vehicle communication, so that when the terminal reports a location, it is unnecessary for all terminals to report locations, which reduces unnecessary location reporting messages, decreases loads on a base station or a network side when the terminal reports the location, and also save uplink resources of the base station or the network side.

The above mentioned descriptions are merely preferred embodiments of the present disclosure, and certainly, should not limit the scope of the present disclosure. Thus, any modification and equivalent according to the claims of the present disclosure, should be still within the scope of the present disclosure.

1. A method for reporting terminal locations in a vehicle communication, executed in a terminal, the method comprising:
detecting a location relationship with other terminals, to determine a target terminal related to a location of the terminal;
reporting location correlation information between the terminal and the target terminal to a base station or network side equipment, to enable the base station or the network side equipment to select a terminal that needs to report a location from the terminal and the target terminal according to the location correlation information.

2. The method of claim 1, wherein the detecting a location relationship with other terminals, to determine a target terminal related to a location of the terminal comprises:
acquiring information of the target terminal related to the location of the terminal from an application layer of the terminal.

3. The method of claim 2, wherein the determining the target terminal related to the location of the terminal through a D2D discovery mechanism comprises:
determining that a location correlation between the terminal and the any terminal does exist, when a location variable between the terminal and any terminal, within a unit time and determinable as being within a predetermined range through the D2D discovery mechanism.

4. The method of claim 1, further comprising:
determining whether a location reporting configuration instruction sent by the base station or the network side equipment is received;
after determining that the location reporting configuration instruction is received, reporting current location information of the terminal to the base station or the network side equipment according to the location reporting configuration instruction, to determine locations of the terminal and the target terminal by the base station or the network side equipment according to the current location information and the location correlation information.

5. A method for reporting terminal locations in a vehicle communication, executed in a base station or network side equipment, the method comprising:
acquiring location correlation information between a plurality of terminals;
selecting a designated terminal that needs to report a location from the plurality of terminals, according to the location correlation information;
sending a location reporting configuration instruction to the designated terminal, to make the designated terminal report its location information according to the location reporting configuration instruction;
determining locations of the plurality of terminals, according to the location information of the designated terminal and the location correlation information.

6. The method of claim 5, wherein the acquiring location correlation information between a plurality of terminals comprises:
receiving the location correlation information send by any one of the plurality of terminals.

7. A device for reporting terminal locations in a vehicle communication, executable on a terminal, the device comprising:
at least one processor; and
a storage device storing a plurality of instructions, which when executed by the at least one processor, causes the at least one processor to:
detect a location relationship with other terminals by a terminal, to determine a target terminal related to a location of the terminal;
report location correlation information between the terminal and the target terminal to a base station or network side equipment, to enable the base station or the network side equipment to select a terminal that needs to report a location from the terminal and the target terminal according to the location correlation information.

8. The device of claim 7, wherein the plurality of instructions, when executed by the at least one processor, further causes the at least one processor to:
acquire information of the target terminal related to the location of the terminal from an application layer of the terminal.

9. The device of claim 8, wherein the plurality of instructions, when executed by the at least one processor, further causes the at least one processor to:
determine that a location correlation between the terminal and the any terminal does exist, when a location variable between the terminal and any terminal, within a unit time and determinable as being within a predetermined range through the D2D discovery mechanism.

10. The device of claim 7, wherein the plurality of instructions, when executed by the at least one processor, further causes the at least one processor to:
judge whether a location reporting configuration instruction sent by the base station or the network side equipment is received;
after determining that the location reporting configuration instruction is received, report current location information of the terminal to the base station or the network side equipment according to the location reporting configuration instruction, to determine locations of the terminal and the target terminal by the base station or the network side equipment according to the current location information and the location correlation information.

11. The device of claim 10, wherein the base station or the network side equipment:
acquires location correlation information between a plurality of terminals;
selects selecting a designated terminal that needs to report a location from the plurality of terminals, according to the location correlation information;
sends a location reporting configuration instruction to the designated terminal, to make the designated terminal report its location information according to the location reporting configuration instruction;
determines locations of the plurality of terminals, according to the location information of the designated terminal and the location correlation information.

12. The device of claim 11, wherein the base station or the network side equipment further
receives the location correlation information send by any one of the plurality of terminals.

13: The method of claim 1, wherein the detecting a location relationship with other terminals to determine a target terminal related to a location of the terminal comprises:
determining the target terminal related to the location of the terminal through a Device-to-Device (D2D) discovery mechanism.

14. The method of claim 2, further comprising:
determining whether a location reporting configuration instruction sent by the base station or the network side equipment is received;
after determining that the location reporting configuration instruction is received, reporting current location information of the terminal to the base station or the network side equipment according to the location reporting configuration instruction, to determine locations of the terminal and the target terminal by the base station or the network side equipment according to the current location information and the location correlation information.

15. The method of claim 3, further comprising:
determining whether a location reporting configuration instruction sent by the base station or the network side equipment is received;
after determining that the location reporting configuration instruction is received, reporting current location information of the terminal to the base station or the network side equipment according to the location reporting configuration instruction, to determine locations of the terminal and the target terminal by the base station or the network side equipment according to the current location information and the location correlation information.

16: The method of claim 5, wherein the acquiring location correlation information between a plurality of terminals comprises:
receiving location information reported by each of the plurality of terminals, and determining location correlation information between the plurality of terminals according to the location information reported by each of the plurality of terminals.

17: The device of claim 7, the at least one processor further:
determines the target terminal related to the location of the terminal through a Device-to-Device (D2D) discovery mechanism.

18: The device of claim 8, wherein the plurality of instructions, when executed by the at least one processor, further causes the at least one processor to:
judge whether a location reporting configuration instruction sent by the base station or the network side equipment is received;
after determining that the location reporting configuration instruction is received, report current location information of the terminal to the base station or the network side equipment according to the location reporting configuration instruction, to determine locations of the terminal and the target terminal by the base station or the network side equipment according to the current location information and the location correlation information.

19: The device of claim 9, wherein the plurality of instructions, when executed by the at least one processor, further causes the at least one processor to:
judge whether a location reporting configuration instruction sent by the base station or the network side equipment is received;
after determining that the location reporting configuration instruction is received, report current location information of the terminal to the base station or the network side equipment according to the location reporting configuration instruction, to determine locations of the terminal and the target terminal by the base station or the network side equipment according to the current location information and the location correlation information.

20: The device of claim 11, the base station or the network side equipment further receives location information reported by each of the plurality of terminals, and determine location correlation information between the plurality of terminals according to the location information reported by each of the plurality of terminals.
